(19) United States
(12) Patent Application Publication
(10) Pub. No.: US 2008/0091719 A1
(43) Pub. Date: Apr. 17, 2008

(54) Audio tags

(76) Inventors: Robert Thomas Arenburg, Round Rock, TX (US); Franck Barillaud, Austin, TX (US); Bradford Lee Cobb, Cedar Park, TX (US); Shivnath Dutta, Round Rock, TX (US)

Correspondence Address: IBM CORP (YA);C/O YEE & ASSOCIATES PC, P.O. BOX 802333, DALLAS, TX, 75380, US

(21) Appl. No.: 11/549,235

(22) Filed: Oct. 13, 2006

(51) Int. Cl. G06F 17/00

(52) U.S. Cl. 707/104.1

(57) ABSTRACT

A computer implemented method and computer program product for managing audio information. The process retrieves an audio stream comprising audio information. The process generates a pair of audio tags in an audio tag frequency band. The audio tag frequency band is a frequency band different than the frequency band of the audio information. The audio tags correspond to a given function. The process superimposes the audio tags on the audio information to form a tagged audio information segment. The process retrieves the tagged audio information segment from the audio stream corresponding to the given function in response to receiving a selection of the given function. The tagged audio information segment can be managed according to the function to which the audio tags have been associated.

### BACKGROUND OF THE INVENTION

1. Field of the Invention

The present invention relates generally to an improved data processing system and in particular to managing audio information. More particularly, the present invention is directed to a computer implemented method, apparatus, and computer program product for utilizing audio tags corresponding to a given function in order to manage audio information contained within an audio stream.

2. Description of the Related Art

An audio stream contains audio information that is delivered to a user as a continuous stream. For example, an audio stream includes, but is not limited to, a live telephone transmission, a pre-recorded telephone transmission, an audio/sound file, such as a MP3 player file, real-time audio downloaded from the Internet, a sound recording, such as a recording on a compact disc (CD) or compact disc-read only memory (CD-ROM), or any other type of known or available audio or sound content. Audio information is the audio or sound content of the audio stream that is heard by a user. For example, audio information in a telephone transmission includes the content of the conversation between the participants of the phone conversation.

Currently, a user desiring to preserve one or more portions of audio information for later reference, such as a topic of information, is required to handwrite notes or manually transcribe the segments of the audio information relating to a topic of interest. For example, a user on a telephone conference call can handwrite notes regarding topics discussed during the conference call that are of interest to the user. However, a user may miss other information discussed during the conversation while attempting to transcribe a previous portion of the conversation. In addition, a user may transcribe erroneous information due to misunderstanding the audio information the first time the user hears the information, incorrectly transcribing the information while attempting to follow the rest of the conversation or otherwise performing another task during the conversation, and/or forgetting the substance of the information before all the information can be correctly transcribed.

Alternatively, users can record the entire audio information content for later reference. For example, a user can record an entire phone conversation for later review. However, a user must replay the entire audio recording of the conversation until the desired segment of the audio information is found. This process of retrieving discrete portions of the recorded conversation is time consuming and inefficient.

A user can also have the entire content of the audio information transcribed into text format. However, a user must still read the transcript to locate the segments of interest. A user may tab, highlight, or otherwise mark the desired portions of the transcript to easily reference the desired information in the future. However, the process of reading, tabbing the pages, and highlighting portions of the transcript can also be time consuming and inefficient for a user.

If a user is interested in multiple topics, the user can use different colored tabs and highlighting to distinguish different segments of the transcript corresponding to different topics. However, this method requires a sufficient number of different colored tabs and/or highlighters. In addition, locating segments corresponding to a particular topic can be inaccurate if a user misses one or more tabs, tabs are lost, moved, or mistakenly removed, and/or a user fails to remember or record which color corresponds to a desired topic. Thus, marking audio information segments corresponding to a desired topic in a written transcript and then locating segments corresponding to a topic of interest can be clumsy, time consuming, and inaccurate.

### SUMMARY OF THE INVENTION

The illustrative embodiments described herein provide a computer implemented method and computer program product for managing audio information. The process receives an audio stream comprising audio information. The process generates a pair of audio tags in an audio tag frequency band. The audio tag frequency band is a frequency band different than the frequency band of the audio information. The audio tags correspond to a given function. The process superimposes the audio tags on the audio information to form a tagged audio segment. The process retrieves the tagged audio information segment from the audio stream corresponding to the given function in response to receiving a selection of the given function.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a pictorial representation of a network of data processing systems in which illustrative embodiments may be implemented;

FIG. 2 is a block diagram of a data processing system in which the illustrative embodiments may be implemented;

FIG. 3 is a block diagram illustrating a data flow in a process for managing audio information in accordance with an illustrative embodiment;

FIG. 4 is a diagram of an audio stream with an audio tag frequency band superimposed on an audio information frequency band in accordance with an illustrative embodiment; and

FIG. 5 is a flow chart of a process for managing audio information in accordance with an illustrative embodiment.

### DETAILED DESCRIPTION OF THE PREFERRED EMBODIMENT

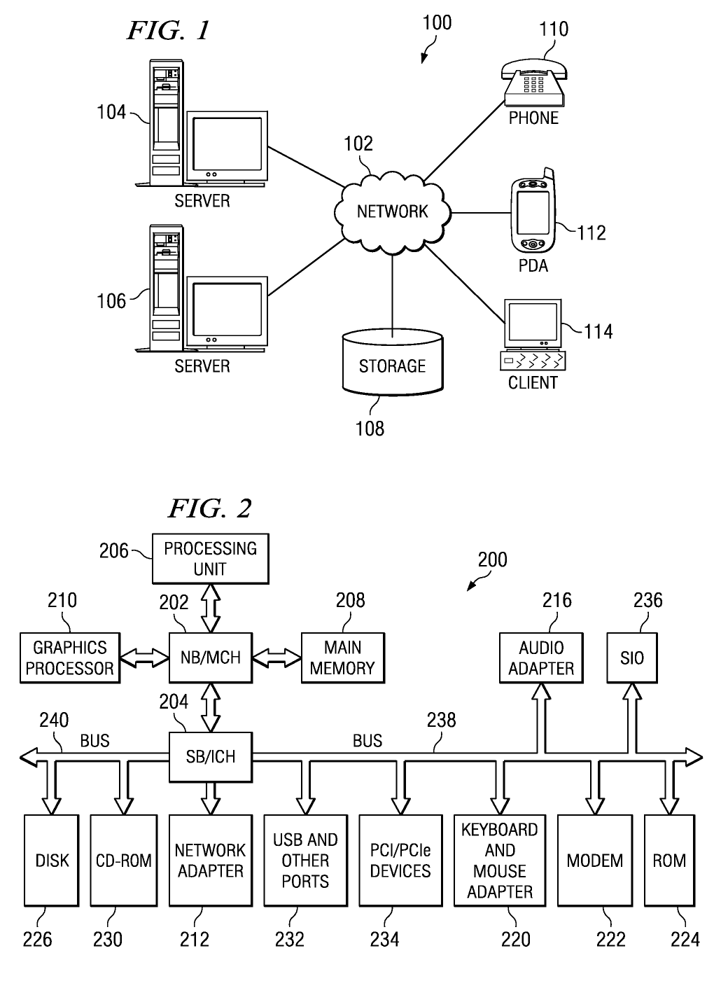

With reference now to the figures and in particular with reference to FIGS. 1-2, exemplary diagrams of data processing environments are provided in which illustrative embodiments may be implemented. It should be appreciated that FIGS. 1-2 are only exemplary and are not intended to assert or imply any limitation with regard to the environments in which different embodiments may be implemented. Many modifications to the depicted environments may be made.

With reference now to the figures, FIG. 1 depicts a pictorial representation of a network of data processing systems in which illustrative embodiments may be implemented. Network data processing system 100 is a network of computing devices in which embodiments may be implemented. Network data processing system 100 contains network 102, which is the medium used to provide communications links between various devices and computers connected together within network data processing system 100. Network 102 may include connections, such as wire, wireless communication links, or fiber optic cables. The depicted example in FIG. 1 is not meant to imply architectural limitations. For example, data processing system 100 also may be a network of telephone subscribers and users.

In the depicted example, server 104 and server 106 connect to network 102 along with storage unit 108. In addition, phone 110, PDA 112, and client 114 are coupled to network 102. Phone 110, PDA 112, and client 114 are examples of audio devices used to transmit audio information throughout network data processing system 100. Audio information is a form of data exchangeable in network data processing system 100. For example, audio information includes, but is not limited to, spoken words, music, or any other sounds or audio data. The illustrative embodiments of the present invention can be implemented to tag audio information transmitted by network data processing system 100.

Phone 110 may be, for example, an ordinary wired telephone, a wireless telephone, a cellular (cell) phone, satellite phone, or voice over internet phone. Personal digital assistant (PDA) 112 may be any form of personal digital assistant, such as Palm OS®, Windows Mobile® Pocket PC®, Blackberry®, or other similar handheld computing device. Client 114 may be, for example, a personal computer, laptop, tablet PC, or network computer. In the depicted example, server 104 provides data, such as boot files, operating system images, and applications to phone 110, PDA 112, and client 114. Phone 110, PDA 112, and client 114 are coupled to server 104 in this example. Network data processing system 100 may include additional servers, phones, PDAs, clients, and other audio or computing devices not shown.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, network data processing system 100 also may be implemented as a number of different types of networks, such as for example, an intranet, a local area network (LAN), a wide area network (WAN), a telephone network, or a satellite network. FIG. 1 is intended as an example, and not as an architectural limitation for different embodiments.

With reference now to FIG. 2, a block diagram of a data processing system is shown in which illustrative embodiments may be implemented. Data processing system 200 is an example of a computing device, such as server 104 or phone 110 in FIG. 1, in which computer usable code or instructions implementing the processes may be located for the illustrative embodiments.

In the depicted example, data processing system 200 employs a hub architecture including a north bridge and memory controller hub (MCH) 202 and a south bridge and input/output (I/O) controller hub (ICH) 204. Processor 206, main memory 208, and graphics processor 210 are coupled to north bridge and memory controller hub 202. Graphics processor 210 may be coupled to the MCH through an accelerated graphics port (AGP), for example.

In the depicted example, local area network (LAN) adapter 212 is coupled to south bridge and I/O controller hub 204 and audio adapter 216, keyboard and mouse adapter 220, modem 222, read only memory (ROM) 224, universal serial bus (USB) ports and other communications ports 232, and PCI/PCIe devices 234 are coupled to south bridge and I/O controller hub 204 through bus 238, and hard disk drive (HDD) 226 and CD-ROM drive 230 are coupled to south bridge and I/O controller hub 204 through bus 240. PCI/PCIe devices may include, for example, Ethernet adapters, add-in cards, and PC cards for notebook computers. PCI uses a card bus controller, while PCIe does not. ROM 224 may be, for example, a flash binary input/output system (BIOS). Hard disk drive 226 and CD-ROM drive 230 may use, for example, an integrated drive electronics (IDE) or serial advanced technology attachment (SATA) interface. A super I/O (SIO) device 236 may be coupled to south bridge and I/O controller hub 204.

An operating system runs on processor 206 and coordinates and provides control of various components within data processing system 200 in FIG. 2. The operating system may be a commercially available operating system such as Microsoft® Windows® XP (Microsoft and Windows are trademarks of Microsoft Corporation in the United States, other countries, or both). An object oriented programming system, such as the Java™ programming system, may run in conjunction with the operating system and provides calls to the operating system from Java programs or applications executing on data processing system 200. Java and all Java-based trademarks are trademarks of Sun Microsystems, Inc. in the United States, other countries, or both.

Instructions for the operating system, the object-oriented programming system, and applications or programs are located on storage devices, such as hard disk drive 226, and may be loaded into main memory 208 for execution by processor 206. The processes of the illustrative embodiments may be performed by processor 206 using computer implemented instructions, which may be located in a memory such as, for example, main memory 208, read only memory 224, or in one or more peripheral devices.

The hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. Also, the processes of the illustrative embodiments may be applied to a multiprocessor data processing system.

In some illustrative examples, data processing system 200 may be a personal digital assistant (PDA), which is generally configured with flash memory to provide non-volatile memory for storing operating system files and/or user-generated data. A bus system may be comprised of one or more buses, such as a system bus, an I/O bus and a PCI bus. Of course the bus system may be implemented using any type of communications fabric or architecture that provides for a transfer of data between different components or devices attached to the fabric or architecture. A communications unit may include one or more devices used to transmit and receive data, such as a modem or a network adapter. A memory may be, for example, main memory 208 or a cache such as found in north bridge and memory controller hub 202. A processing unit may include one or more processors or CPUs. The depicted examples in FIGS. 1-2 and above-described examples are not meant to imply architectural limitations. For example, data processing system 200 also may be a tablet computer, laptop computer, or telephone device in addition to taking the form of a PDA.

The illustrative embodiments described herein provide a computer implemented method, apparatus, and computer program product for managing audio information. The process receives an audio stream comprising audio information. The audio stream can be received in an audio device. An audio device is any known or available device for receiving and/or transmitting audio information, including but not limited to, a telephone, cellular telephone, or personal digital assistant (PDA).

The process generates a pair of audio tags in an audio tag frequency band in order to delimit and identify a portion of an audio stream containing audio information. The pair of audio tags is associated with a unique identifying number and a given function, such as a “to do” list, “follow up items,” or any other user definable category. A frequency band is a frequency or range of frequencies in an audio stream containing one type of information. For example, an audio tag frequency band contains pairs of audio tags used to delimit portions of audio information to create a tagged audio information segment. The audio tag frequency band is a frequency band different than the frequency band comprising the audio information.

The process superimposes the audio tag frequency band on the audio information frequency band to form a tagged audio segment. Superimposing the audio tag frequency band consists of overlaying the audio tag frequency band onto the audio stream containing the audio information frequency band. In this manner, the original audio information remains unaltered. Further, the two separate frequency bands can be later separated if necessary.

Using this method, the process can easily retrieve tagged audio information segments from the audio stream corresponding to a requested function in response to receiving a selection of the given function.

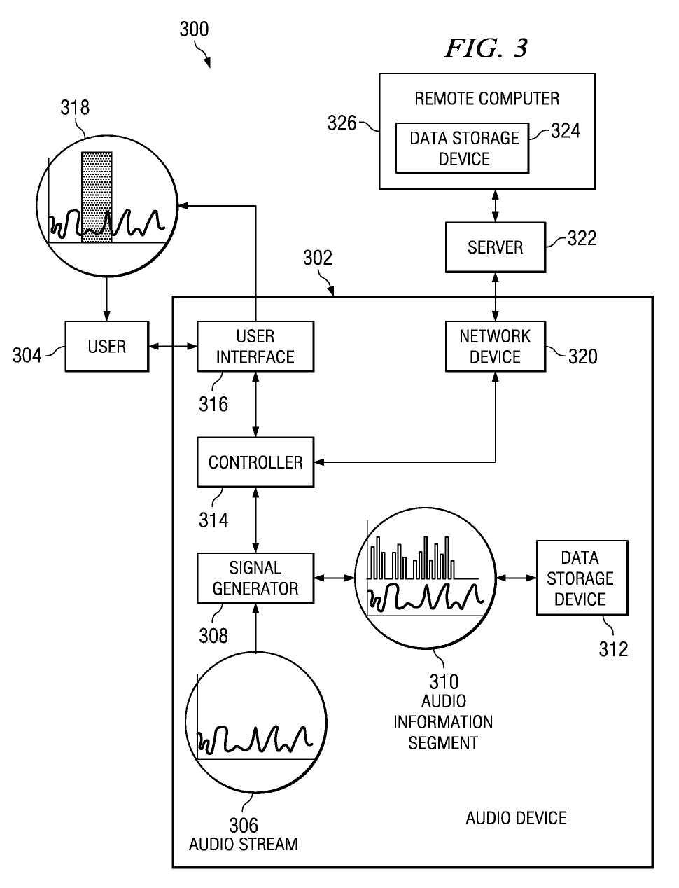

Turning now to FIG. 3, a block diagram illustrating a data flow in a process for managing audio information is depicted in accordance with an illustrative embodiment. Data processing system 300 is a data processing system such as data processing system 200 in FIG. 2.

Audio device 302 is an audio device for sending and receiving audio content contained in an audio stream. Audio device 302 can include, but is not limited to, a telephone, a PDA, a computer, or any other known or available for receiving and/or sending an audio stream. In this illustrative example, audio device 302 is a telephone such as phone 110 in FIG. 1. User 304 utilizes audio device 302 to listen to audio content and select segments of the audio content that are of interest to user 304.

Audio device 302 receives an audio stream, such as audio stream 306. An audio stream includes audio information that is delivered to a user as a continuous stream of audio information. Audio stream 306 is not required to be heard by a user in real-time or live as the audio stream is being transmitted. Audio information includes sound or audio content, such as the content of a telephone conversation or radio broadcast.

Audio device 302 receives audio stream 306 from another audio device, such as phone 110, PDA 112, or client 114 depicted in FIG. 1. Audio device 302 can also retrieve audio stream 306 from a data storage device containing the audio information. In another embodiment, audio device 302 can generate audio stream 306 based on input from one or more users rather than receiving or retrieving the audio stream from another audio device.

Audio device 302 plays the audio content of audio stream 306 for user 304 via user interface 316. User 304 utilizes user interface 316 to select one or more segments of the audio stream to be tagged.

Signal generator 308 is a hardware component that generates audio tags for managing audio information. This hardware component may take different forms depending on the particular implementation. For example signal generator 308 may be implemented using a processor, a digital signal processor, or an application specific integrated circuit (ASIC). Signal generator 308 generates audio tags in an audio tag frequency band. A frequency band is defined as a specific frequency or a range of frequencies in an audio stream. A frequency band contains information. Information can include audio information or pairs of audio tags used to delimit portions of audio information. For example, audio stream 306 may contain audio information in the form of spoken language, which may populate an audio information frequency band of 80-350 Hz. Further, signal generator 308 may generate pairs of audio tags in the 3000 Hz audio tag frequency band. The audio tag frequency band is a different frequency band than one containing the audio information within audio stream 306. In these illustrative examples, each pair of audio tags within the audio tag frequency band is associated with a given function and a unique identifier.

In this illustrative embodiment, the audio tag frequency band is a frequency band in the 200-15,000 Hz range. For example, the audio tag frequency band is 3000 Hz. However, the audio tag frequency band can be any frequency band that is at a frequency band different than the audio information frequency band.

In another embodiment, signal generator 308 contains a frequency stripper that filters from the audio stream a given frequency, such as the 3000 Hz frequency band. The audio tag frequency band is superimposed onto audio stream 306 at this frequency, creating tagged audio information segment 310.

Signal generator 308 superimposes the audio tag frequency band onto audio stream 306 to create tagged audio information segment 310 that may be stored in data storage device 312. Signal generator 308 can be implemented by a microprocessor such as those located within telephones. Superimposing the audio tag frequency band onto audio stream 306 in this manner prevents disruption to the actual audio information contained within audio stream 306. In other words, the audio tag frequency band is maintained in audio stream 306 separate from the audio information frequency band, thus permitting signal generator 308 to remove the audio tag frequency band when returning unaltered portions of the audio information to user 304.

In this example, signal generator 308 generates a pair of audio tags to delimit a given segment of audio information. The pair of audio tags comprises a first tag that indicates a starting point of a tagged audio information segment, and a second tag that indicates an ending point of a tagged audio information segment.

Each pair of audio tags is associated with a given function and a unique identifier. A default function is a start/stop pair of audio tags that delimits a portion of audio information from an audio stream. In addition, users can define functions to include categories, actions, to-do lists, types of music, contact information, personal information, numbers/numerical identifiers, colors/color coding, months of the year, or any other type of category or identifier. Consider, for example, a conference call among persons planning a wedding. During the conference call, participants discuss topics concerning potential wedding dates, locations, DJs, and photographers. Prior to the conference call, audio tags are defined such that pressing the button labeled “1” inserts a start/stop audio tag relating to a function “potential wedding dates.” Likewise, the button labeled “2” is associated with the function “wedding locations,” button “3” with DJs, and button “4” with photographers. Thus, in this example, every time participants of this phone call begin to discuss potential wedding dates, a participant can press the button labeled “1” to insert a first audio tag indicating the beginning of the tagged audio information segment relating to wedding dates. Once the conversation relating to wedding dates ends, the participant can press the button labeled “1” again to insert a second audio tag indicating the end of the tagged audio information segment. The process associates a unique identifier to this tagged audio information segment, such as “S1.” Similarly, if participants begin discussing potential wedding locations, a participant can press the button labeled “2” to insert a first and second audio tag delimiting a portion of the conversation relating to wedding locations. The process associates another unique identifier to this tagged audio information segment, such as “S2.” In this manner, a participant can insert audio tags to delimit discrete portions of conversation relating to discrete topics. Based on the given function and unique identifier, the process could then retrieve all tagged audio information at some later time.

Controller 314 differentiates pairs of audio tags according to the unique identifier and their audio patterns. Pairs of audio tags associated with the same function but delimiting a different segment of the audio stream may have tags with the same audio pattern. However, the two different tagged audio information segments can be differentiated by their unique identifier. The identifier can comprise numbers, letters, symbols, or any combination thereof.

A pair of audio tags corresponding to a first function differs from the audio tags corresponding to a second function. In one embodiment, the first and second audio tags comprising a pair of audio tags corresponding to a function have identical audio patterns. In another embodiment, the first and second audio tags comprising a pair of audio tags corresponding to a function have different audio patterns. Furthermore, pairs of audio tags corresponding to different functions have a unique pair of audio tags comprising a first and second audio tag that may also have differing audio patterns.

For example, user 304 can use audio device 302 to superimpose different audio tags onto audio stream 306. In this example, audio device is a phone, such as phone 110 in FIG. 1. The telephone has buttons/controls in an alphanumeric keypad (not shown). Controls indicate one or more functions. User 304 selects a control/button to generate an audio tag at a given segment or portion of the audio stream to form a tagged audio information segment. Thus, pressing the button/control labeled “1” may insert a starting audio tag corresponding to, for example, a “to do” function. Pressing “1” a second time may insert an ending audio tag.

In another embodiment, a different button could correspond to a closing tag. For example, a user could press the control labeled “2”, “*”, or “#”. Thus, pressing one control, such as “1”, can insert a starting audio tag corresponding to a function, such as a “to do” function, and pressing a different control, such as “2”, can insert an ending audio tag for the “to do” function. In this manner, a user can create a tagged audio information segment by using audio tags associated with a “to do” list to delimit a starting and stopping point.

Storage device 312 can store tagged audio information segment 310 for future reference. User 304 operating audio device 302 can interact with user interface 316 to specify a given function for retrieval. User interface 316 is coupled to controller 314 that directs signal generator 308 to retrieve tagged audio information segments from data storage device 312 corresponding to the given function.

Audio device 302 may also contain network adapters to enable data processing system 300 to connect to other audio devices, data processing systems, or remote printers or storage devices through intervening private or public networks. For example, network device 320 is coupled to an external server 322 that is in turn coupled to data storage device 324 coupled to remote computer 326. Modems, cable modem and Ethernet cards are just a few of the currently available types of network adapters.

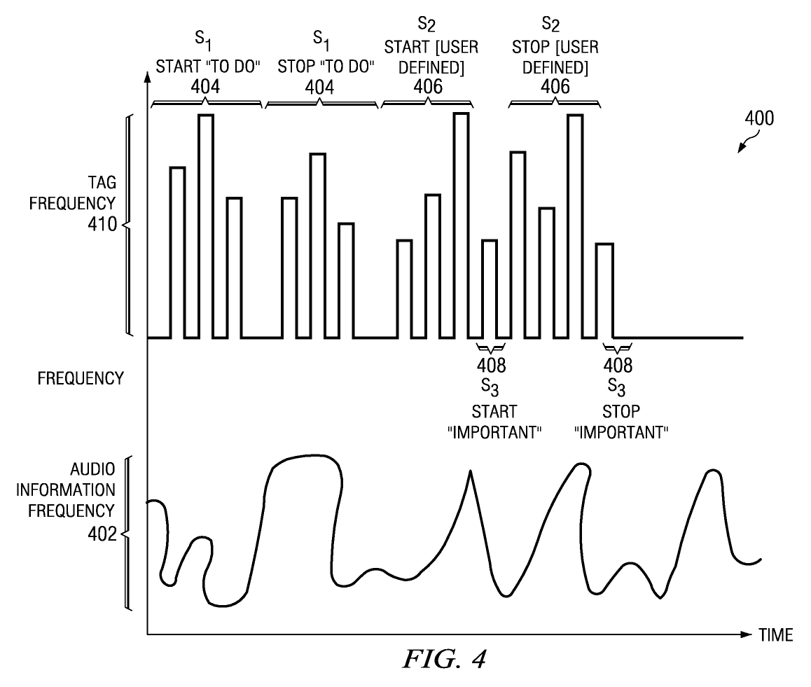

FIG. 4 is a diagram of an audio stream with an audio tag frequency band superimposed on an audio information frequency band in accordance with an illustrative embodiment. Audio stream 400 contains audio content in audio information frequency 402. A signal generator, such as signal generator 308 from FIG. 3, generates pairs of audio tags S1 404, S2 406, and S3 408 in tag frequency 410. The signal generator superimposes audio tag frequency on audio information segment 400.

Each tag in a pair of audio tags is a delimiter indicating a start or end location. Each tag includes a tag identifier, such as S1, S2, and S3, to uniquely identify each tag. Each pair of tags also includes a tag action or function. In this example, audio tags S1 404 identify a specific portion of audio information frequency 402 and corresponds to a “to do” function. Thus, the segment of audio information frequency 402 tagged by audio tags S1 404 are retrieved in response to a user selection of the “to do” function.

Audio tags S2 406 identify a portion of the audio information as a user-defined function including but not limited to categories, actions, to-do lists, types of music, contact information, personal information, numbers/numerical identifiers, colors/color coding, months of the year, or any other type of category or identifier. Audio tags S3 408 associate a portion of the audio information with the function “important.” As illustrated in FIG. 4, audio tags can overlap.

In this illustrative example, a pair of audio tags is utilized to identify a selected segment of audio information. However, in accordance with another illustrative embodiment, a single tag corresponding to a given function is used to identify a segment of audio information. The single tag is programmed to automatically tag a predefined portion of the audio stream. In accordance with another illustrative embodiment, three audio tags corresponding to a given function can be used to tag or identify a given segment of audio information selected by a user.

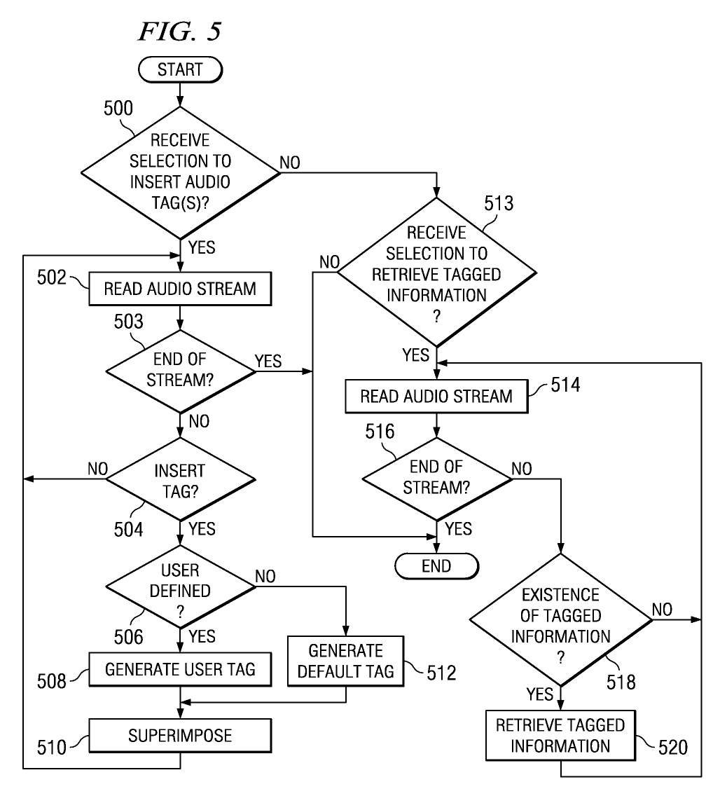

Referring now to FIG. 5, a flowchart of a process for managing audio information is shown in accordance with the illustrative embodiments. In this illustrative example shown in FIG. 5, the process is performed by a hardware device for generating and managing audio tags, such as signal generator 308 in FIG. 3.

The process begins by making a determination as to whether a user input has been received indicating that a user has selected to tag a portion of an audio stream (step 500). In response to receiving a selection to insert a pair of audio tags, the process reads the audio stream (step 502). The process then determines whether the end of the audio stream has been reached (step 503). If the end of the audio stream has been reached without receiving a selection to insert an audio tag, the process terminates thereafter.

If the process does not reach the end of the audio stream, the process makes the determination as to whether a user selection to insert a pair of audio tags is received (step 504). If the selection to insert an audio tag has not been made, then the process returns to step 502 and continues reading the audio stream.

However, in response to receiving a selection to insert a pair of audio tags, the process makes a determination as to whether the selection has been made to insert a pair of user-defined audio tags (step 506). In response to the selection to insert a user-defined audio tag, the process generates a user-defined audio tag (step 508), and superimposes the user-defined audio tag on the audio stream to form a tagged audio information segment (step 510). The process then returns to step 502.

Returning to step 506, absent a selection to insert a user-defined pair of audio tags, the process generates a pair of default audio tags (step 512). The process superimposes the default audio tags on the audio stream to form a tagged audio information segment (step 510). The process then returns to step 502.

Returning now to step 500, if the process makes the determination that a selection to insert audio tags has not been made, the process makes a determination as to whether a selection to retrieve tagged audio information segments has been made (step 513). If no selection to retrieve tagged audio information has been made, the process terminates thereafter.

If the selection to retrieve tagged audio information has been made, the process reads the audio stream (step 514). The process then determines whether the end of the audio stream has been reached (step 516). If the audio stream has terminated, then the process terminates thereafter. Otherwise, the process makes the determination as to whether the audio stream contains tagged audio information segments (step 518).

If the process contains the requested tagged audio information segment, then the process retrieves the tagged audio information segment (step 520) and the process returns to step 514. If at step 518 the process makes the determination that the audio stream does not contain the requested tagged audio information, the process returns to step 514 to continue reading the audio stream until the end of the audio stream is reached, with the process terminating thereafter.

The flowchart and block diagrams in the figures illustrate the architecture, functionality, and operation of some possible implementations of systems, methods and computer program products according to various embodiments. In this regard, each block in the flowchart or block diagrams may represent a module, segment, or portion of code, which comprises one or more executable instruction(s) for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

Thus, the illustrative embodiments described herein provide a computer implemented method, apparatus, and computer program product for managing audio information. The process receives an audio stream comprising audio information and generates a pair of audio tags in an audio tag frequency band in order to delimit and identify a segment of audio information. The pair of audio tags is associated with a unique identifying number and a given function. The process superimposes the audio tag frequency band on the audio information frequency band to form a tagged audio segment.

Using this method, the process can easily retrieve tagged audio information segments from the audio stream corresponding to the given function in response to receiving a selection of the given function. This method facilitates the management of information contained within an audio stream and obviates the need to implement other inefficient, inaccurate, and time consuming methods of managing audio information such as handwriting notes or recording the entire audio stream for subsequent review.

Thus the different embodiments allow for the management of audio information by the dynamic insertion of audio tags into an audio stream to create a tagged audio information segment corresponding to defined functions. Tagged audio information can be stored and retrieved based upon the association of functions with the inserted tags.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A computer implemented method for managing audio information comprising:
receiving an audio stream, wherein the audio stream comprises audio information;
generating a pair of audio tags in an audio tag frequency band, wherein the audio tag frequency band is a different frequency band than a frequency band of the audio information and wherein the pair of tags corresponds to a given function;
superimposing the pair of audio tags on the audio information to form a tagged audio information segment in the audio stream; and
responsive to receiving a selection of the given function, retrieving the tagged audio information segment corresponding to the given function from the audio stream.

2. The computer implemented method of claim 1 wherein the pair of audio tags comprises a first tag and a second tag, and further comprising:
indicating a starting point of the tagged audio information segment by the first tag; and
indicating an ending point of the tagged audio information segment by the second tag.

3. The computer implemented method of claim 1 wherein the step of superimposing the pair of audio tags further comprises:
stripping a segment of the frequency band of the audio information to form a stripped portion of the audio stream, wherein the stripped portion of the audio stream is in a frequency band that is different than the frequency band of the audio information; and
inserting the audio tag frequency band into the stripped portion of the audio stream.

4. A computer program product for managing audio information comprising a computer usable medium having computer usable program code tangibly embodied thereon, the computer usable program code comprising:
computer usable program code for retrieving an audio stream, wherein the audio stream comprises audio information;
computer usable program code for generating a pair of audio tags in an audio tag frequency band, wherein the audio tag frequency band is a different frequency band than a frequency band of the audio information, and wherein the pair of tags corresponds to a given function;
computer usable program code for superimposing the pair of audio tags to the audio information to form a tagged audio information segment in the audio stream; and
computer usable program code for, responsive to receiving a selection of the given function, retrieving the tagged audio information segment corresponding to the given function from the audio stream.

5. The computer program product of claim 4 wherein the pair of audio tags comprises a first tag and a second tag, and further comprising:
computer usable program code for indicating a starting point of the tagged audio information segment by the first tag; and
computer usable program code for indicating an ending point of the tagged audio information segment by the second tag.

6. The computer program product of claim 4 wherein the step of superimposing the audio tags further comprises:
computer usable program code for stripping a segment of the frequency band of the audio information to form a stripped portion of the audio stream, wherein the stripped portion of the audio stream is in a frequency band that is different than the frequency band of the audio information; and
computer usable program code for inserting the audio tag frequency band into the stripped portion of the audio stream.
